(19) United States
(12) Patent Application Publication
(10) Pub. No.: US 2006/0219873 A1
(43) Pub. Date: Oct. 5, 2006

(54) Detection system for a flow cytometer

(76) Inventors: Steven M. Martin, Ann Arbor, MI (US); Colin A. Rich, Ypsilanti, MI (US); Nathaniel C. Bair, Ann Arbor, MI (US)

Correspondence Address: SCHOX PLC, 209 N. MAIN STREET #200, ANN ARBOR, MI, 48104, US

(21) Appl. No.: 11/400,890

(22) Filed: Mar. 31, 2006

Related U.S. Application Data
(60) Provisional application No. 60/667,381, filed on Apr. 1, 2005.

(51) Int. Cl. H01J 40/14

(52) U.S. Cl. 250/214 R

(57) ABSTRACT

The detection system 10 of the first preferred embodiment is preferably designed to be integrated into a flow cytometer having an interrogation zone 12. The detection system 10 includes a detector 14 adapted to receive photonic inputs P from the interrogation zone and produce an analog signal, and an analog-to-digital converter (ADC) 20 coupled to the detector and adapted to convert an analog signal to a digital signal. The detector 14 has a dynamic range that is preferably greater than or equal to 100 dB. The ADC 20 has a bit resolution that is preferably greater than or equal to 16-bits. The detection system allows simultaneous collection of both small/faint objects and large/bright objects. In an application of this feature of the present invention, the detection system of the preferred embodiments may be used in the co-detection of mammalian cells and bacteria.

### CROSS-REFERENCE TO RELATED APPLICATIONS

This application claims the benefit of US Provisional Application No. 60/667,381, filed 01 Apr. 2005 and entitled “Flow Cytometer System With Full Range Signal Collection”, which is incorporated in its entirety by this reference.

### TECHNICAL FIELD

The present invention relates generally to the field of flow cytometers, and more particularly to the field of detection systems for flow cytometers.

### BACKGROUND

A typical flow cytometer includes an exciter, an interrogation zone, and a detector. The detector functions to collect signals from objects, ranging from small to large, in the interrogation zone. The typical detector has a limited collection range, and is typically provided with a gain level. To collect signals from small objects, the gain level is increased. With an increased gain level, however, the signals from large objects are too bright to be collected. Accordingly, to collect signals from large objects, the gain level is decreased. With a decreased gain level, however, the signals from small objects are too faint to be collected. Thus a fundamental problem with flow cytometry is the selection of gain levels for the amplifiers operating on the detector signal.

In quantitative terms, the collection range for a typical flow cytometer with a photomultiplier tube is three to four decades, where a decade is defined as a logarithmic measurement interval consisting of a multiplication or division by a power of ten. In flow cytometry, the signal range of the objects may span five or more decades across experiments, i.e. a range of 1-100,000 units or more between data points. As such, the collection range of a typical flow cytometer is smaller than the signal range of the objects. For this reason, users are typically required to pre-set the gain levels of the detector by setting one or more voltages for the photomultiplier tubes and/or amplifier gains such that they correspond to an anticipated range of data points for the objects.

The requirement of this set-up step, which must occur before the collection of any data, has two disadvantages. First, the user must expend valuable time and energy in anticipating the appropriate range for collection and data processing. Secondly, any pre-selection of the detector gain necessarily includes the potential loss of valuable data because the user incorrectly anticipated the actual signal range and a portion or more of the input signals are outside the user-set collection range and are not collected.

Accordingly, there is a need in the art to create a new and improved detection system for a flow cytometer that avoids or minimizes these disadvantages. The present invention provides such new and improved detection system for a flow cytometer.

### BRIEF DESCRIPTION OF THE FIGURES

FIG. 1 is a schematic block diagram of a flow cytometer system in accordance with a first preferred embodiment of the present invention.

FIG. 2 is a schematic block diagram of a flow cytometer system in accordance with a second preferred embodiment of the present invention.

FIG. 3 is a schematic block diagram of a flow cytometer system in accordance with a third preferred embodiment of the present invention.

### DESCRIPTION OF THE PREFERRED EMBODIMENTS

The following description of various preferred embodiments of the invention is not intended to limit the invention to these preferred embodiments, but rather to enable any person skilled in the art of flow cytometers to make and use this invention.

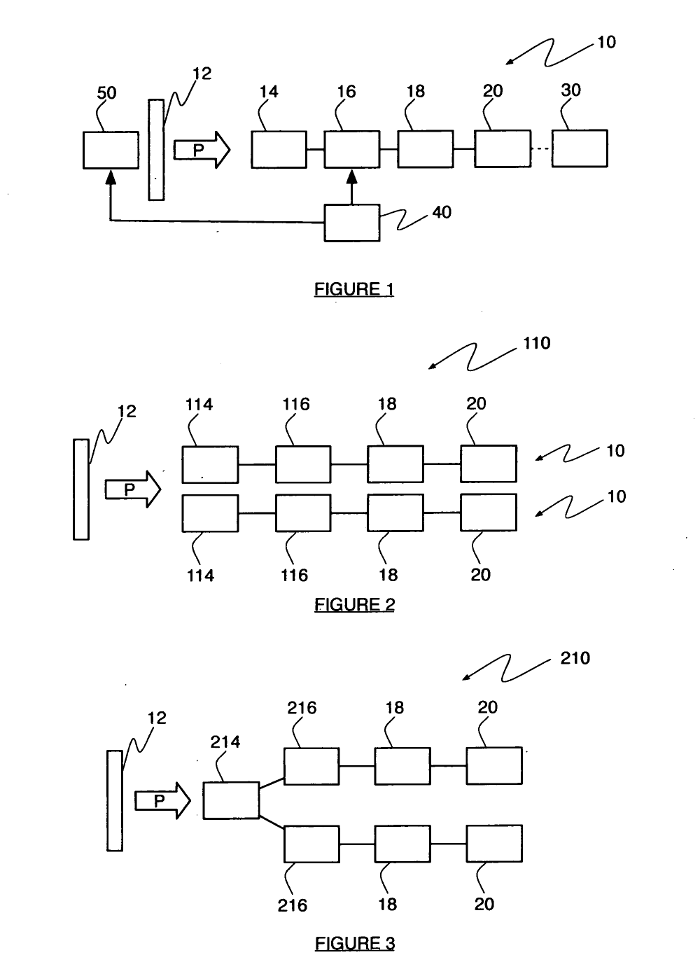

As shown in FIG. 1, the detection system 10 of the first preferred embodiment is preferably designed to be integrated into a flow cytometer having an interrogation zone 12. The detection system 10 includes a detector 14 adapted to receive photonic inputs P from the interrogation zone 12 and produce an analog signal, and an analog-to-digital converter (ADC) 20 coupled to the detector 14 and adapted to convert an analog signal to a digital signal. The detector 14 has a dynamic range that is preferably greater than or equal to 100 dB. The ADC 20 has a bit resolution that is preferably greater than or equal to 16-bits, and more preferably greater than or equal to 24-bits.

The detection system 10 of the first preferred embodiment allows simultaneous collection of both small/faint objects and large/bright objects. In an application of this feature of the present invention, a flow cytometer may be used in the co-detection of mammalian cells and bacteria. The average diameter of mammalian cells is between 10 and 30 microns, while the average diameter of bacteria or yeast is between 1 and 4 microns. The relative diameters of these objects are disparate enough that they generally cannot be properly examined using a single gain setting on a typical flow cytometer. With such a flow cytometer, however, it is possible to examine both mammalian cells and bacteria simultaneously in the same sample.

The detector 14 of the preferred embodiment functions to receive photonic inputs from the interrogation zone and produce analog signals based on these photonic inputs. The detector 14 is preferably operable over a wide dynamic range. As used herein, the term “wide dynamic range” is preferably defined as greater than or equal to 100 dB. The detector 14 preferably has a luminous sensitivity between 80 and 120 microamps per lumen, but may alternatively have a luminous sensitivity of any suitable value. The detector 14 is preferably operable over a spectral range of approximately 400 to 700 nanometers, but may alternatively be operable over any suitable spectral range. Preferably, the detector 14 includes one or more PIN photodiodes and a synchronous detection unit (not shown). The PIN photodiodes function to receive photonic inputs P from an interrogation zone 12, and convert the impending electromagnetic radiation into an electrical signal. Although a PIN photodiode is preferred, the detector 14 may use other suitable detection devices with a wide dynamic range, such as specialized photomultipliers or other photodiodes. The synchronous detection unit functions to provide the fidelity for the input signals in the lower end of the signal range. The synchronous detection unit is preferably similar to the synchronous detection unit disclosed in U.S. Ser. No. 10/198,378, filed 18 Jul. 2002 and entitled “Flow Cytometer and Detection System of Lesser Size”, which is incorporated in its entirety by this reference. Although this synchronous detection unit is preferred, the detector 14 may use other suitable signal conditioners. Further, in certain circumstances, the detector 14 may omit the synchronous detection unit, which would yield a circuit with wide dynamic range, but less luminous sensitivity.

The detection system 10 of the preferred embodiment further includes an amplifier 16 that is coupled to the detector 14. The amplifier 16 preferably receives the electrical signal of the detector 14 and amplifies the signal by a predetermined amount, depending upon the strength of the output and the breadth of the detector range. Alternatively, the amplifier 16 may include variable attenuators such that the amplifier 16 applies a dynamically variable gain to the signal. Although the amplifier 16 preferably operates in the electrical domain, the amplifier 16 may alternatively operate in the optical domain. For example, the amplifier 16 may be integrated or partially integrated into the detector 14, such as in the case of an avalanche photodiode (APD), which is an amplified photodetector known in the art. The preferred amplifier 16 has a signal-to-noise ratio (SNR) ranging between approximately 100 dB and 120 dB.

The detection system 10 of the first preferred embodiment also includes an automatic gain control (AGC) unit 40. The AGC unit 40 is preferably coupled to both an exciter 50 and the amplifier 16. Alternatively, the AGC unit 40 may be coupled to either the exciter 50 or the amplifier 16. Operating on the amplifier 16, the AGC unit 40 functions to dynamically vary the gain of the amplifier 16 with respect to the analog signal produced by the detector 14. This dynamic gain control allows a single detector 14 with limited dynamic range to track an input signal with much larger dynamic range. Operating on the exciter 50, the AGC unit 40 functions to dynamically vary the output of the exciter 50, thereby varying the signal excited in the interrogation zone 12 and by extension the optical properties of the photonic inputs P. The AGC unit 40 further functions to keep the generated signal within the dynamic range of the detector 14. The AGC unit 40 may be integrated into the amplifier 16, the exciter 50, or both. Alternatively, the AGC unit may be remotely coupled to the amplifier 16, the exciter 50 or both.

The detection system 10 of the first preferred embodiment further includes a compression unit 18 that is coupled to the amplifier 16. The compression unit 18 functions to reduce the dynamic range of the plurality of electrical signals from the amplifier 16 and compress that data into an electrical signal with a smaller dynamic range that is appropriate for the ADC 20 of the preferred system. In the preferred embodiment, the detection system 10 incorporates signal compression to obtain better resolution for the input signals in the lower end of the signal range. The compression unit 18 preferably uses a nonlinear compression algorithm, such as a logarithmic compression algorithm, but may use a linear, parametric, or any other suitable approach. In alternative embodiments, the detection system 10 may omit the compression unit 18.

The ADC 20 of the detection system 10 functions to convert an analog signal into a digital signal that is readily usable by a digital circuit, processor, or computing device. The ADC 20 preferably includes a high bit resolution. As used herein, the term “high bit resolution” is preferably defined as greater than or equal to 16-bits, and more preferably defined as greater than or equal to 24-bits. The ADC 20 preferably includes a Signal-to-Noise Ratio (SNR) of approximately greater than 100 dB, but may alternatively include a SNR of any suitable value.

The detection system 10 of the preferred embodiment preferably interfaces with an analysis engine 30, which functions to apply gain and scaling factors to the acquired data, independent of the acquisition step. The analysis engine 30 may be configured as a software and/or hardware module. In an alternative variation, the detection system 10 and the analysis engine 30 may be physically separated. That is, the detection system 10 might store raw collected data on a memory device (such as a CD-ROM or other such media), which can then be removed and/or transferred to the analysis engine 30 (such as a PC) for analysis. This approach has the advantage of minimizing the use time by each user of the detection system 10. The collection of the data in this manner eliminates the expenditure of valuable user time during the pre-set step and avoids the potential loss of valuable data.

As shown in FIG. 2, the detection system 110 of the second preferred embodiment is also preferably designed to be integrated into a flow cytometer having an interrogation zone 12. The detection system 110 includes more than one detection systems 10 of the first preferred embodiment (as shown in FIG. 1). The detection systems 10 preferably operate on the same photonic input from the interrogation zone 12, but cover substantially different (overlapping or non-overlapping) subsets of the dynamic range of the photonic input. Like the first preferred embodiment, the detection system 110 of the second preferred embodiment allows simultaneous collection of both small/faint objects and large/bright objects. The difference between the first preferred embodiment and the second preferred embodiment, however, includes the use of one or more detectors to divide the responsibility of the detector 14.

The detectors 114 preferably have smaller dynamic ranges (on the order of 50-60 dB), set at different portions (overlapping or non-overlapping) of the dynamic range of the photonic input. Preferably, the amplifiers 116 complement the respective detectors 114, such that a high-gain amplifier is matched with one detector, and a low-gain amplifier is matched with another detector. Alternatively, the amplifiers 116 may have identical or substantially identical gain and SNR values. Except for the variations mentioned, the detection systems 10 are preferably identical to the detection system 10 of the first preferred embodiment (as shown in FIG. 1).

As shown in FIG. 3, the detection system 210 of the third preferred embodiment is also preferably designed to be integrated into a flow cytometer having an interrogation zone 12. The detection system 210 of the third preferred embodiment is similar to the detection system 110 of the second preferred embodiment (shown in FIG. 2), except that the detectors have been merged back into one detector 214. In this embodiment, the amplifiers 216 preferably operate on the output from the detector 214, but amplify the analog signal from the detector 214 at different gain levels. Like the other preferred embodiments, the detection system 210 of the third preferred embodiment allows simultaneous collection of both small/faint objects and large/bright objects. The difference between the third preferred embodiment and the first preferred embodiment, however, includes the use of more than one amplifier to divide the responsibility of the amplifier 16.

The amplifiers 216 of the third preferred embodiment are preferably set at distinct gain levels (e.g., one is set with a higher gain level, while the other is set at a lower gain level), but the amplifiers 216 may be set at similar gain levels and then dynamically controlled according to the AGC unit or any other suitable device or method. Except for the variations mentioned, the detection system 210 of the third preferred embodiment is preferably identical to the detection system 110 of the second preferred embodiment (as shown in FIG. 2).

As a person skilled in the art of flow cytometers will recognize from the previous detailed description and from the figures and claims, modifications and changes can be made to the preferred embodiments of the invention without departing from the scope of this invention defined in the following claims.

We claim:

1. A detection system for a flow cytometer having an interrogation zone, comprising:
a detector adapted to receive photonic inputs from the interrogation zone and produce an analog signal, the detector having a wide dynamic range; and
an analog-to-digital converter (ADC) coupled to the detector and adapted to convert an analog signal to a digital signal, the ADC having a high bit resolution.

2. The detection system of claim 1 further comprising an amplifier coupled to the detector.

3. The detection system of claim 2 wherein the amplifier is adapted to apply a dynamically variable gain to the analog signal.

4. The detection system of claim 2 further comprising an automatic gain control unit coupled to an exciter and adapted to dynamically vary an excitation signal of the exciter.

5. The detection system of claim 1 wherein the detector comprises a first detector and a second detector, wherein the first and second detectors operate on the same channel.

6. The detection system of claim 5 wherein the first detector includes a first dynamic range and the second detector includes a second dynamic range, such that the first detector and the second detector cooperate as a detector having a wide dynamic range.

7. The detection system of claim 5 further comprising a first amplifier coupled to the first detector, and a second amplifier coupled to the second detector.

8. The detection system of claim 7 wherein the first amplifier includes a first gain and the second amplifier includes a second gain, and wherein the first and second gains are distinct.

9. The detection system of claim 7 wherein the first and second amplifiers are adapted to apply a dynamically variable gain to the analog signals.

10. The detection system of claim 7 further comprising an automatic gain control unit coupled to an exciter and adapted to dynamically vary an excitation signal of the exciter.

11. The detection system of claim 1 further comprising a first amplifier and a second amplifier, wherein the detector is coupled to the first amplifier and to the second amplifier.

12. The detection system of claim 11 wherein the first amplifier includes a first gain and the second amplifier includes a second gain, and wherein the first and second gains are distinct.

13. The detection system of claim 11 wherein the first and second amplifiers are adapted to apply a dynamically variable gain to the analog signal.

14. The detection system of claim 11 further comprising an automatic gain control unit coupled to an exciter and adapted to dynamically vary an excitation signal of the exciter.

15. The detection system of claim 1 further comprising a synchronous detection unit.

16. The detection system of claim 1 wherein the high bit resolution of the ADC is defined as greater than or equal to 16-bits.

17. The detection system of claim 1 further comprising a signal compression unit adapted to compress and transmit signals to the ADC.

18. The detection system of claim 1 wherein the detector is a photomultiplier.

19. The detection system of claim 1 wherein the detector is a photodiode.

20. The detection system of claim 1 wherein the wide dynamic range of the detector is defined as greater than or equal to 100 dB.
